(19) United States
(12) Patent Application Publication
(10) Pub. No.: US 2010/0152993 A1
(43) Pub. Date: Jun. 17, 2010

(54) FUEL MONITORING METHOD AND SYSTEM

(75) Inventors: William Joseph Antel, JR., Freising (DE); Aaron Jay Knobloch, Mechanicville, NY (US); Brian Allen Engle, Armada, MI (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/335,563

(22) Filed: Dec. 16, 2008

(51) Int. Cl. F02D 41/00

(52) U.S. Cl. 701/103; 73/114.52

(57) ABSTRACT

A fuel-monitoring system include a fuel source to supply an air and fuel mixture, a sensing device to receive the air and fuel mixture from the fuel source and require a compensatory power supply due to flow of the air and fuel mixture; and a processing device for determining an amount of fuel in the fuel source by relating the compensatory power supply required by the sensing device to the amount of fuel in the fuel source.

### BACKGROUND

This invention relates generally to a fuel monitoring system and more particularly to a system and method for determination of fuel quantity in a fuel source.

Automobiles, for example, passenger cars, small and large trucks, off-road vehicles have a fuel tank where fuel is stored and used for combustion in a combustion engine. While fuel from the fuel tank is supplied to a combustion engine, a considerable amount of the fuel evaporates and leads to an undesirable waste of fuel and increased emissions. Conventional systems often employ a canister, typically filled with carbon, to collect the evaporated fuel. The evaporated fuel is then purged from the canister into an intake manifold and burned in combustion chambers along with the fuel that is injected via fuel injectors from the fuel tank.

An engine controller controls the timing of the purging of the carbon canister to the combustion engine. The engine controller controls injectors that input an air-fuel mixture for optimizing fuel consumption, emissions and prevention of the combustion engine knock or stall. To accomplish this the engine controller must have an accurate measurement of an amount of fuel trapped in the canister.

Conventional methods measure the amount of fuel with an oxygen sensor, such as a switching Heated Exhaust Gas Oxygen sensor (HEGO) or a linear Universal Exhaust Gas Oxygen sensor (UEGO). The oxygen sensor senses the amount of air in the fuel after combustion of the fuel and outputs a voltage based upon a corresponding amount of air in the fuel. An air-to-fuel ratio is computed based upon the output voltage. An approximate amount of fuel is further determined from the air-to-fuel ratio. For example, a high concentration of air (lean air-to-fuel ratio) corresponds to a low voltage signal and vice versa. The, oxygen sensor measures the amount of oxygen after combustion of the fuel. Accordingly, the detection of the amount of fuel in the fuel source is delayed.

Accordingly, there is a need in the industry to accurately measure the amount of fuel within an automobile's carbon canister or a similar environment in a near real time manner.

### BRIEF DESCRIPTION

In accordance with one exemplary embodiment of the present invention a fuel-monitoring system is provided. The fuel-monitoring system comprises a fuel source configured to supply an air and fuel mixture, a sensing device configured to receive the air and fuel mixture from the fuel source and measure a compensatory power supply required for the air and fuel mixture, and a processing device for determining an amount of fuel in the fuel source by correlating the required compensatory power supply to the amount of fuel in the fuel source.

In accordance with another embodiment of the present invention, a method of monitoring fuel is provided. The method includes supplying an air and fuel mixture from a fuel source; flowing the air and fuel mixture in contact with hotplates of a sensing device; measuring a compensatory power supply required for the air and fuel mixture by the sensing device; and determining an amount of fuel in the fuel source by correlating the compensatory power required by the sensing device to the amount of fuel in the fuel source by a processing device.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic view of a fuel monitoring system in accordance to one embodiment of the invention.

FIG. 2 illustrates a micro hotplate sensor as an embodiment of the sensing device, used in the fuel monitoring system indicated with reference to FIG. 1.

FIG. 3 is an embodiment of the fuel monitoring system having multiple sensing devices for increasing the range of fuel quantities that can be measured by the fuel monitoring system.

FIG. 4 is a flow chart illustrating a fuel monitoring method to determine an amount of fuel in the fuel source in accordance with one embodiment of the invention.

FIG. 5 is an exemplary graphical illustration depicting the calibration of fuel quantity in the fuel source against the change in power.

### DETAILED DESCRIPTION

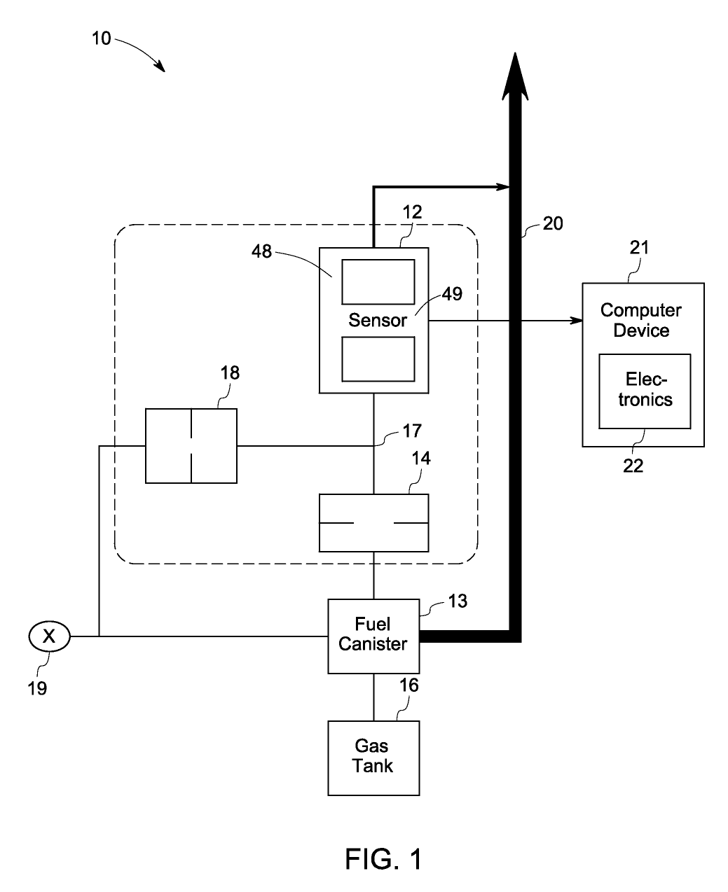

FIG. 1 is a schematic view of a fuel monitoring system 10 in accordance with one embodiment of the invention. The fuel monitoring system 10 includes a fuel source 13, or canister, connected to a fuel tank 16 and an air source 19. The fuel tank 16 stores fuel and directs it to the fuel source 13 on command of a processing device 21. In one embodiment, the fuel leaks out from the fuel tank to the fuel source 13. This fuel is collected by the fuel source 13, typically in the form of fuel vapor. The fuel source 13 also receives air from the air source 19, which air gets mixed with the fuel in the fuel source 13 to form a combustible mixture of air and fuel hereinafter “air-fuel mixture.” In one embodiment, the air source 19 is a combustion engine air intake. In still another embodiment, the air source 19 further includes an air filter to purify the air of contaminants and particulates.

The fuel monitoring system 10 includes a fuel control device 14 in communication with the fuel source 13 to control a flow of the air-fuel mixture going to the sensing device 12 from the fuel source 13. In one embodiment, the fuel control device 13 is an orifice plate.

In one embodiment, the air-fuel mixture supplied to the sensing device 12 through the fuel control device 14 is also supplied to an engine (not shown) through a fuel manifold 20. In order to satisfy the lean air-fuel mixture requirement of the sensing device 12, an air control device 18 directs air to the sensing device 12 through a supply line 17. In one embodiment the air control device 18 includes at least one air inlet that directs a supply of air from the air supply source 19 to the sensing device 12. In one embodiment the air control device 18 is a purge valve.

The air-fuel mixture supplied to the sensing device 12 is mixed with the air from the air control device 18 resulting in a leaner air-fuel mixture hereinafter “lean air-fuel mixture.” In one embodiment, the air from the air control device 18 is mixed with the air-fuel mixture supplied to the sensing device 12 resulting in the lean air-fuel mixture having a predetermined ratio of air and fuel. In still another embodiment of the invention, the air from the air control device 18 mixed with the air-fuel mixture from the fuel control device that is supplied to the sensing device 12 is constant. In one more embodiment, the processing device 21 of the fuel monitoring system 10 is coupled to the air control device 18 to automate the air control device.

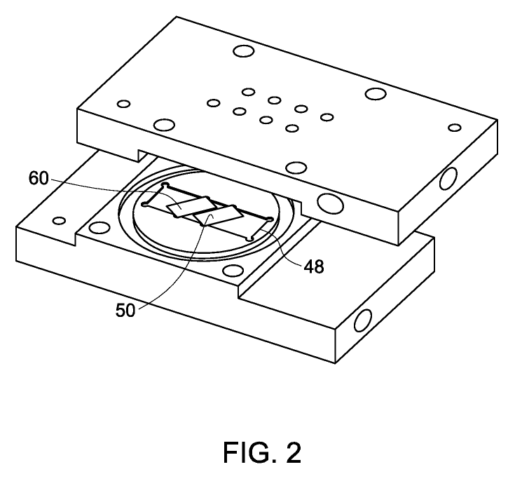

The sensing device 12 includes a reference micro-hotplate 50 and a catalyst micro hotplate 60 positioned within a chamber 48 that defines an enclosure 49. An embodiment of the sensing device 12 is illustrated with reference to FIG. 2. In operation, the lean air-fuel mixture from the supply line 17 passes through the sensing device 12 and varies temperature of the reference micro-hotplate and/or the catalyst micro-hotplate 60. Hence, sensor control electronics 22 are employed to maintain a constant temperature of the reference micro-hotplate and/or the catalyst micro-hotplate. The sensor control electronics 22 are typically in communication with the sensing device 12 to facilitate an active control of the temperature of the reference micro-hotplate 50 and/or the catalyst micro-hotplate 60 by varying the power to the reference micro-hotplate 50 and/or the catalyst micro-hotplate 60 respectively.

In an exemplary embodiment, heat from the reference micro-hotplate 50 is transferred to the air-fuel mixture while in contact. This results in a convective and conductive power loss in the reference micro-hotplate 50 leading to variation in temperature. The convective and conductive power loss is monitored via the sensor control electronics 22. A compensatory power is supplied to the reference micro-hotplate 50 in order to maintain a constant temperature. Similarly, contact of the catalyst micro-hotplate 60 with the lean air-fuel mixture leads to combustion resulting in increase in temperature of the catalyst micro-hotplate 60. Accordingly, a compensatory power is supplied to the catalyst micro-hotplate 60 in order to maintain a constant temperature. In one embodiment, the processing device 21 is interfaced with the sensor control electronics 22 to monitor and/or record the compensatory power. In still another embodiment and as shown in FIG. 1, the sensor control electronics 22 is a component or module of the processing device 21.

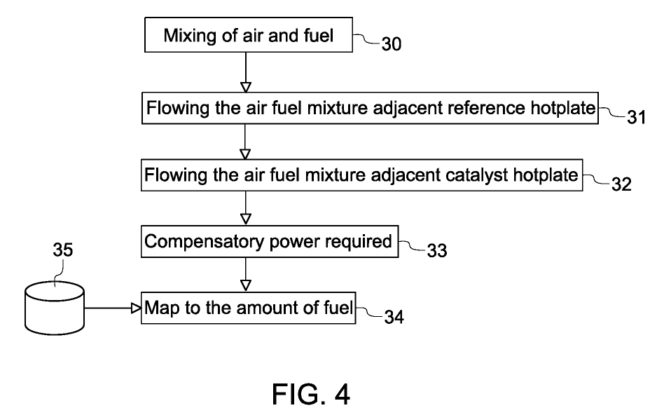

The compensatory power supplied to the reference micro-hotplate 50 and/or the catalyst micro-hotplate 60 is directly related to an amount of fuel in the fuel source 13. The compensatory power required by the sensing device is thus used to determine the amount of fuel in the fuel source, the method of which is discussed in greater detail with reference to FIG. 4. In one embodiment, the sensor control electronics 22 output a signal proportional to the amount of fuel in the fuel source 13. The time response of the reference micro-hotplate 50 and/or the catalyst micro-hotplate 60 is on the order of milliseconds resulting in a near-real time determination of the amount of fuel in the fuel source 13.

FIG. 2 illustrates a micro hotplate sensor 45 as an embodiment of the sensing device 12, used in the fuel monitoring system 10 in FIG. 1. The micro hotplate sensor 45 includes the reference micro-hotplate 50 and the catalyst micro-hotplate 60 as illustrated in brief with reference to FIG. 1. As shown in FIG. 2, the reference micro-hotplate 50 and the catalyst micro-hotplate 60 are positioned within a chamber 48. In one embodiment, the reference micro-hotplate 50 is aligned in series with the catalyst micro-hotplate 60. In an alternative embodiment, the reference micro-hotplate 50 is aligned in parallel with the catalyst micro-hotplate 60 with respect to a direction of the air-fuel mixture flow through the chamber 48. As shown in FIG. 2, the micro-hotplate sensor, for example, includes one reference micro-hotplate 50 and one catalyst micro-hotplate 60. However, the sensor 45 can include any suitable number of the reference micro-hotplates 50 and/or the catalyst micro-hotplates 60 to increase combustion conversion efficiency. It is apparent to those skilled in the art and guided by the teachings herein provided that any suitable number of the reference micro-hotplates 50 and/or the catalyst micro-hotplates 60 can be used in parallel and/or in series with respect to the direction of the air-fuel mixture flow within the chamber 48.

The reference micro-hotplate 50 is typically coated by a porous material. In one embodiment the reference micro hotplate 50 includes a silicon nitride membrane suspended from a frame of silicon. The reference micro-hotplate 50 is fabricated from an alumina material. In alternative embodiments, the reference micro-hotplate 50 is fabricated from any suitable material known to those skilled in the art and guided by the teachings herein provided.

The catalyst micro-hotplate 60 is typically coated by a catalyst suspended in a porous material. In one embodiment, the catalyst micro-hotplate 60 includes a silicon nitride membrane suspended from a frame of silicon. At least a portion of the catalyst micro-hotplate 60 is coated with a catalyst. In other alternative embodiments, a supported catalyst coating material is applied to a support material of the catalyst micro-hotplate 60 on flow surface. The particular choice of catalyst and operating temperature is dependent upon the application. The catalyst can be, for example, a noble metal, noble metals with additives (e.g., copper), semiconducting oxides and/or hexaaluminate materials. The catalyst can be supported in high-temperature-stable, high-surface-area materials, such as alumina, hexaaluminates, zirconia, ceria, titania or hydrous metal oxides (e.g., hydrous titanium oxide (HTO), silica-doped hydrous titanium oxide (HTO:Si), and silica-doped hydrous zirconium oxide (HZO:Si)). These supported catalysts have good stability and reactivity and help to mitigate against reliability problems and failure modes by insulating the catalyst micro-hotplate 60 from the harsh combustion conditions. In one embodiment, the catalyst micro-hotplate 60 includes an alumina-supported catalyst including a noble metal, such as Pt or Pd, supported in an alumina matrix.

The supported catalyst can be deposited on the flow surface of the catalyst micro-hotplate 60. In one embodiment, the catalyst is thick enough to provide sufficient catalytic activity, but thin enough to allow for adequate heat transfer between the micro-hotplate surface and the catalyst surface in contact with air-fuel mixture to be combusted. Reliable deposition of the catalysts is desirable in order to achieve consistent performance. The catalysts are deposited onto the flow surface of the catalyst micro-hotplate 60 using any suitable process known in the art and guided by the teachings herein provided.

Other suitable materials for fabricating reference micro-hotplate 50 and/or catalyst micro-hotplate 60 are disclosed in U.S. Pat. No. 6,786,716 issued to Gardner, et al. on Sep. 7, 2004, the disclosure of which is incorporated herein in its entirety by reference thereto. In other alternative embodiments, the reference micro-hotplate 50 and/or the catalyst micro-hotplate 60 include any suitable support material and/or coating material known to those skilled in the art and guided by the teachings herein provided.

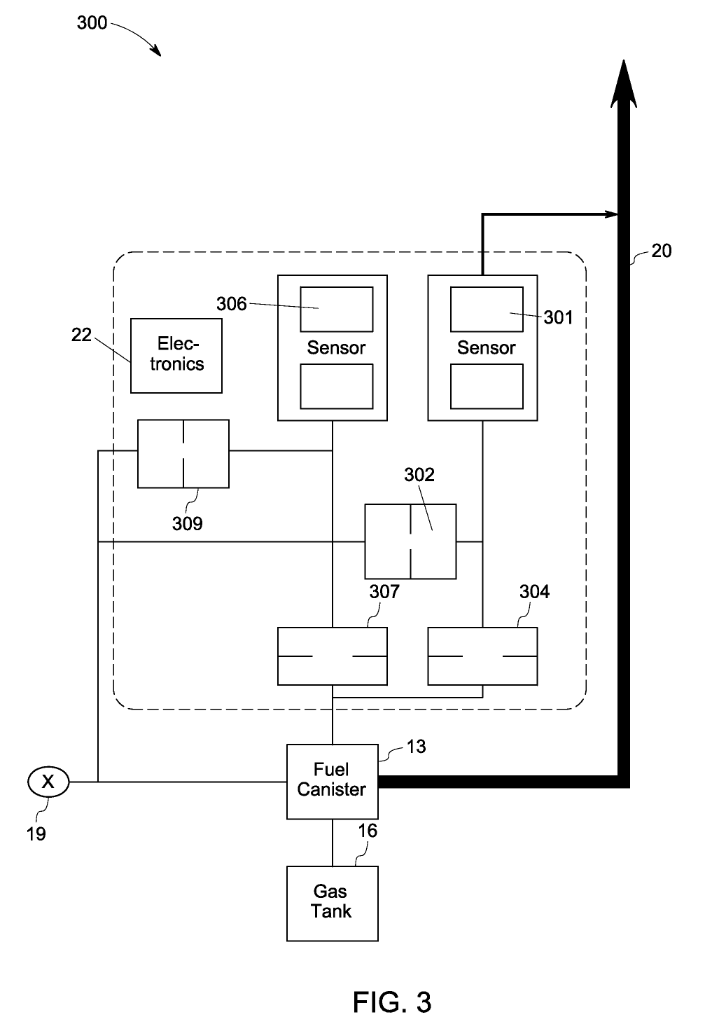

FIG. 3 is an embodiment of the fuel monitoring system 300 having multiple sensing devices for increasing the range of fuel amount quantities that can be measured by the fuel monitoring system 300. In this embodiment, the fuel monitoring system 300 includes at least two sensing devices 301, 306 that are in an operational communication with air control devices 302, 309, respectively. The fuel monitoring system 300 also includes sensor control electronics 22 to control the sensing devices 306, 308. The air control devices 302, 309 direct air received from the air source 19 to the sensing devices 301, 306, respectively. In this embodiment, the fuel monitoring system 300 also includes two fuel control devices 304, 307 in operational communication with the sensing devices 301, 306, respectively. The fuel control devices 304, 307 receive the air-fuel mixture from the fuel source 13 (illustrated with reference to FIG. 1) and directs the air fuel mixture to the sensing devices 301, 306. As illustrated with reference to FIG. 1, the air control devices 302, 309 and fuel control devices 304, 307 control flow rate of air from the air source 19 and the air-fuel mixture from the fuel source 13, respectively. Air from the air control devices 302, 309 and air-fuel mixture from the fuel control devices 304, 307 get mixed forming two lean air-fuel mixtures including lean air-fuel mixture 1 and lean air-fuel mixture 2 in the sensing devices 301, 306, respectively.

In operation, in one embodiment of the invention, the air-fuel mixture flow rate from the fuel control device 304 is different from the air-fuel mixture flow rate from the fuel control device 307. Also, in this embodiment, the airflow rate from the air control devices 302, 309 is constant. The difference in the flow rates of the fuel control devices 304, 307 results in a stoichiometry of the lean air-fuel mixture 1 different from the stoichiometry of the lean air-fuel mixture 2.

In operation, in another embodiment of the invention, the airflow rate from the air control device 302 is different from the airflow rate from the air control device 309. Also, in this embodiment, the air-fuel mixture flow rate from the fuel control devices 304, 307 is constant. The difference in the flow rates of the air control devices 302, 309 results in a stoichiometry of the lean air fuel mixture 1 different from the stoichiometry of the lean air-fuel mixture 2.

In operation, in still another embodiment of the invention, airflow rate from the air control device 302 is different from the airflow rate from the air control device 309. Also, in this embodiment the air-fuel mixture flow rate from the fuel control device 304 is different from the air-fuel mixture flow rate from the fuel control device 307. The difference in the flow rates of the air control devices 302, 309 and the difference in the flow rates of the fuel control devices 304, 307 results in a stoichiometry of the lean air fuel mixture 1 different from the stoichiometry of the lean air-fuel mixture 2.

The difference in stoichiometry of the lean air-fuel mixture 1 and lean air fuel mixture 2 results in an expansion of the range of equivalence ratios Φ of the air-fuel mixtures. The increase in the range of equivalence ratios Φ of the lean air-fuel mixture results in an expansion of the range of fuel amount quantities that can be measured by the fuel monitoring system 300.

FIG. 4 is a flow chart illustrating a fuel monitoring method to determine an amount of fuel in the fuel source 13 in accordance to one embodiment of the invention. In step 30 the fuel monitoring method mixes an amount of fuel with air to provide a combustible air-fuel mixture. In one embodiment, flow of the air and fuel is controlled before mixing such that the air-fuel mixture has a predetermined ratio of air and fuel. In still another embodiment, the air and fuel is mixed such that the air-fuel mixture is lean and thus the air-fuel mixture has an equivalence ratio denoted by Φ less than one.

In step 31, the air-fuel mixture is directed to flow adjacent the reference micro-hotplate 50 such that the air-fuel mixture is in contact with the reference micro-hotplate 50. The air-fuel mixture reduces temperature of the reference micro-hotplate due to conductive and convective heat loss. A compensatory power is supplied to the reference micro-hotplate 50 to maintain its temperature constant. The sensor control electronics 22 register the compensatory power supplied to the reference micro-hotplate 50.

In step 32, the air-fuel mixture is directed to flow adjacent the catalyst micro-hotplate 60 such that the air-fuel mixture is in contact with the catalyst micro-hotplate 60. The air-fuel mixture is combusted as the air-fuel mixture flows adjacent the catalyst micro-hotplate 60. The combustion leads to an increase in temperature of the catalyst micro-hotplate 60. Thus, the sensor control electronics 22 provide a compensatory power supply to the catalyst micro-hotplate 60 to maintain the catalyst micro-hotplate at a constant temperature.

In step 33, a total compensatory power supplied to the reference micro-hotplate 50 and the catalyst micro-hotplate 60 (hereinafter reference micro-hotplate 50 and catalyst micro-hotplate collectively denoted as “micro-hotplates”) is measured. The compensatory power required by the micro-hotplates 50, 60 is equal to a difference in the compensatory power supplied to the reference micro-hotplate and the catalyst micro-hotplate. For example, if the compensatory power supplied to the reference micro-hotplate is Pᵣ and the compensatory power required by the catalyst micro-hotplate is P_{c}, then the total compensatory power supplied by the sensor control electronics 22 is Pᵣ−P_{c}.

In one embodiment, the total compensatory power is measured repeatedly for different known amounts of fuel in the fuel source 13 (FIG. 1). The measurements of the variation in the total compensatory power required for the different known amounts of fuel in the fuel source 13 are used by the processing device 21 (FIG. 1) to calibrate the compensatory power corresponding to an amount of fuel in the fuel source 13. The calibration is then stored in a storage device 35 by the processing device 21. In an alternative embodiment, the calibration can be done by a least square fit on points mapped for total compensatory power supply in a graph against an amount of fuel in the fuel source. The least square fit is used to establish an equation defining a relationship between the total compensatory power and the amount of fuel in the fuel source 13. The least square fit method using a graph is illustrated in detail with reference to FIG. 4.

In step 34, the total compensatory power is mapped to a corresponding amount of fuel using the calibration stored in the storage device 35.

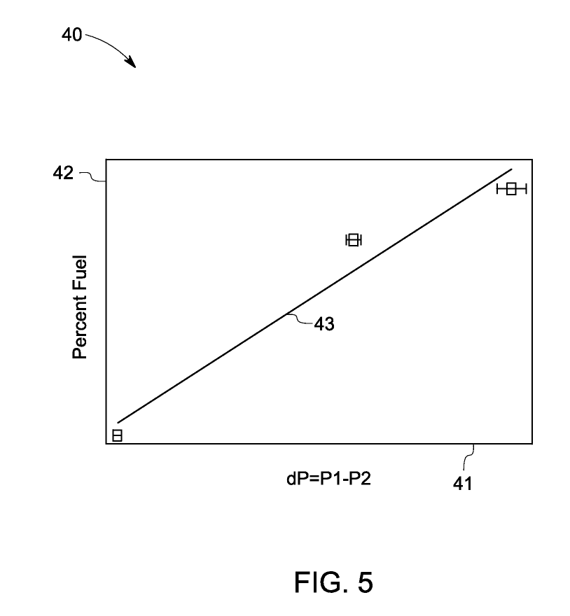

FIG. 5 is an exemplary graphical illustration depicting calibration of fuel quantity in the fuel source 13 (FIG. 1) against the compensatory power. The graph 40 has the percentage of fuel mapped as Y-axis 42 and compensatory power mapped as X-axis 41. The graph 40 has points mapped for compensatory power required by the micro-hotplates against different amounts of fuel in the fuel source 13. A line 43 is fit on maximum number of the points such that an equation is established between the compensatory power and amount of fuel as follows:

Amount of fuel=aΔP+b (1)

where ΔP is compensatory power and is equal to Pᵣ−P_{c} and a and b are coefficients.

The coefficients a and b are determined by using the graph 40 for different known amounts of fuel in the fuel source 13 corresponding to the compensatory power. The values of a and b can vary depending on the type of sensing devices, working conditions of the system including other factors. In one embodiment, the coefficients are determined for different values of known amount of fuel and the corresponding compensatory power supplied. The coefficients are then substituted along with the compensatory power in the equation 1 to determine the amount of fuel in the fuel source.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A fuel-monitoring system comprising:
a fuel source configured to supply an air and fuel mixture;
a sensing device configured to receive the air and fuel mixture from the fuel source and measure a compensatory power supply required for said air and fuel mixture; and
a processing device for determining an amount of fuel in the fuel source by correlating the required compensatory power supply to the amount of fuel in the fuel source.

2. The system of claim 1 wherein the sensing device comprises plurality of sensing devices.

3. The system of claim 1 wherein the sensing device comprises a plurality of hotplates held in a number of fixtures, the fixtures providing electrical contacts to the hotplates and forming a flow path for the fuel.

4. The system of claim 3 wherein the hotplates are covered by a catalyst suspended in a porous material.

5. The system of claim 3 wherein the hotplates are coated by a porous material.

6. The system of claim 3 further comprising a sensor control device to maintain a constant temperature of each of the plurality of hotplates.

7. The system of claim 1 further comprising an air flow control device for controlling an amount of air mixed with the air and fuel mixture before entering the sensing device.

8. The system of claim 7 wherein the air flow control device has an orifice sized such that the amount of air mixed with the air and fuel mixture is constant.

9. The system of claim 1 further comprising a fuel control device for controlling flow of the air and fuel mixture.

10. The system of claim 9 wherein the fuel flow control device is an orifice sized such that the amount of the air-fuel mixture mixed with the air from the air control device results in a combustible air-fuel mixture.

11. The system of claim 1 further comprising an air source for supplying air to the fuel source.

12. The system of claim 11 wherein the air source is an engine air filter.

13. The system of claim 11 wherein the air is atmospheric air.

14. The system of claim 1 wherein the fuel is in vapor form.

15. The system of claim 1 wherein the fuel is in liquid form.

16. A method of monitoring fuel comprising:
supplying an air and fuel mixture from a fuel source;
flowing the air and fuel mixture in contact with hotplates of a sensing device;
measuring a compensatory power supply required for said air and fuel mixture by the sensing device;
determining an amount of fuel in a fuel source by correlating the compensatory power required by the sensing device to the amount of fuel in the fuel source by a processing device.

17. The method of claim 16 further comprising mixing predetermined amount of air to the air and fuel mixture.

18. The method of claim 16 wherein flow rate of the air is controlled to keep the amount of air mixed with the air and fuel mixture constant.

19. The method of claim 16 wherein flow rate of the air and fuel mixture is controlled to a predetermined value.

20. The method of claim 16 wherein temperature of the hotplates is maintained constant.

21. The method of claim 16 wherein measuring the change in power includes measuring power supplied to the hotplates due to the convective and conductive heat transfer from the hotplates to the air and fuel mixture.

22. The method of claim 16 wherein measuring the change in power includes measuring power supplied to the hotplates due to combustion of the air and fuel mixture.
